(19) United States
(12) Patent Application Publication
(10) Pub. No.: US 2011/0044146 A1
(43) Pub. Date: Feb. 24, 2011

(54) ERASURE INFORMATION MARKING METHOD FOR BURST CUTTING AREA OF BLU-RAY DISC

(75) Inventors: Chia-Ming Chang, Hsinchu County (TW); Ping-Chiang Yang, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SUNPLUS TECHNOLOGY CO., LTD., Hsinchu (TW)

(21) Appl. No.: 12/577,738

(22) Filed: Oct. 13, 2009

(30) Foreign Application Priority Data
Aug. 24, 2009 (TW) 98128389

(51) Int. Cl. G11B 27/36

(52) U.S. Cl. 369/53.21; G9B/27.052

(57) ABSTRACT

An erasure information marking method for a burst cutting area (BCA) of a blu-ray disc (BD) is provided. The erasure information marking method includes obtaining at least four raw data recorded in the BCA; recognizing a record type of the BCA according to the four raw data; obtaining two duplicate copyright protection data, relating to the copyright protection of the BD, in the four raw data according to the record type of the BCA; and marking the erasure information of the BCA according to the difference between the two duplicate copyright protection data.

### CROSS-REFERENCE TO RELATED APPLICATION

This application claims the priority benefit of Taiwan application serial no. 98128389, filed on Aug. 24, 2009. The entirety of the above-mentioned patent application is hereby incorporated by reference herein and made a part of specification.

### BACKGROUND OF THE INVENTION

1. Field of the Invention

The present invention relates to an erasure information marking method for a burst cutting area (BCA) of a blu-ray disc (BD).

2. Description of the Related Art

Along with the awareness of copyright protection, optical storage mediums (for example, digital video disc (DVD), blu-ray disc (BD), etc.) having a mechanism for anti-copying also flourish accordingly. Take the BD for example, each recordable BD (for example, BD-R/BD-RE) has a circle of burst cutting area (BCA) recorded by high power laser thereon and the BCA of each recordable BD records a unique copyright protection data.

Accordingly, when data is to be recorded in a recordable BD, the copyright protection data recorded in the BCA of this recordable BD must be demodulated firstly and then encoded with user data, such that the data can be recorded in this recordable BD. For reading data, if the copyright protection data recorded in the BCA is not demodulated, the user data recorded in the disc data area is also not demodulated successfully. Therefore, when user wants to copy the BD, which has recorded data, by using a commercial blu-ray recorder, since the commercial blu-ray recorder is incapable of writing data in the BCA, so that even though the encoded user data is copied, the newly copied disc can not be read successfully if the copyright protection data recorded in the BCA is not copied, so as to achieve the purpose of anti-copying or bulk-copying.

In practical, when a long scratch or a big area dirty spot is on the BD, it may cause that the demodulated copyright protection data from the BCA occurs the burst error. Moreover, since the encoding method for the data of the BCA defined as the specification of the BD is one-hot encoding, so that after the copyright protection data with the burst error is demodulated, it may not occur error(s) correspondingly and thus may not mark the corresponding erasure information, or may occur additional error(s) correspondingly and thus additionally marking the corresponding erasure information.

Herein, if an error correction is performed to the demodulated data according to the incorrect erasure information, for example, the erasure information, which should be marked, is not marked; or the erasure information, which should not be marked, is marked. The copyright protection data recorded in the BCA may not be correctly demodulated because of exceeding the system error correction capability, and thus causing that the BD is not accessed.

From the above, how to correctly mark the erasure information for the BCA of the BD is an important topic of the field of the invention, namely, the erasure information, which should be marked, is marked; and the erasure information, which should not be marked, is not marked.

### SUMMARY OF THE INVENTION

Accordingly, the present invention is directed to an erasure information marking method for a burst cutting area (BCA) of a blu-ray disc (BD). The erasure information marking method includes obtaining at least four raw data recorded in the BCA; recognizing a record type of the BCA according to the four raw data; obtaining two duplicate copyright protection data, relating to the copyright protection of the BD, in the four raw data according to the record type of the BCA; and marking an erasure information of the BCA according to the difference between the two duplicate copyright protection data.

The erasure information marking method submitted by the present invention utilizes the special record format for the BCA of the BD to mark the erasure information by cross-matching corresponding positions between two duplicate copyright protection data. Therefore, the present invention can correctly mark the erasure information for the BCA of the BD. Moreover, the present invention can limit the error correction capability to only the error detection capability without marking the erasure information, so as to achieve the error detection capability without defining as the original specification of the BD.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a blu-ray disc (BD) according to an embodiment of the present invention.

FIGS. 2A to 2D are respectively a diagram of a record type for a burst cutting area of a BD according to an embodiment of the present invention.

FIG. 3 is a flow chart of an erasure information marking method for a burst cutting area of a BD according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

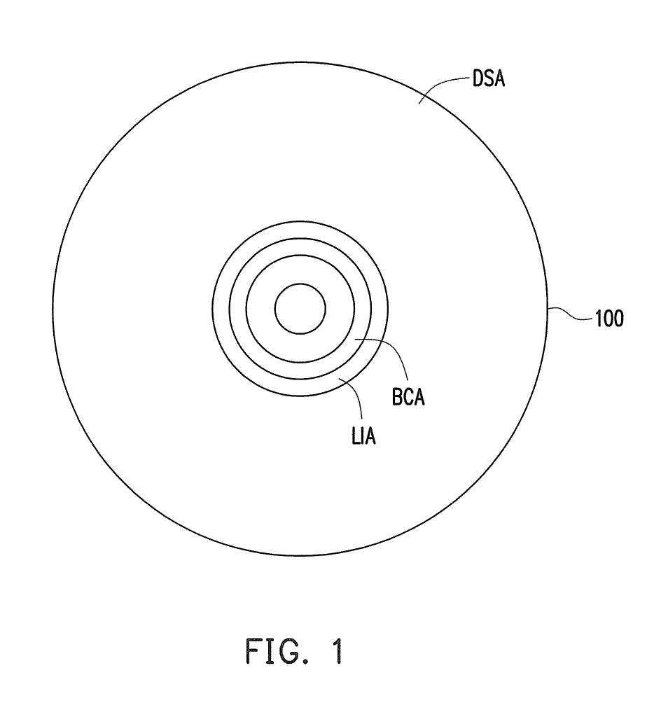

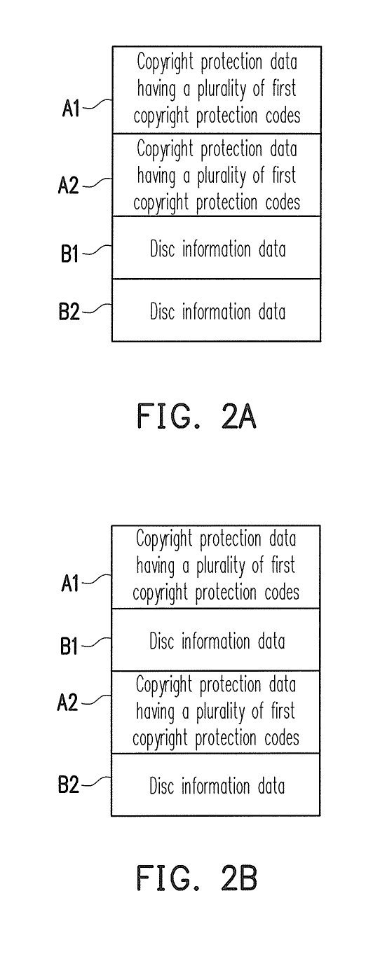

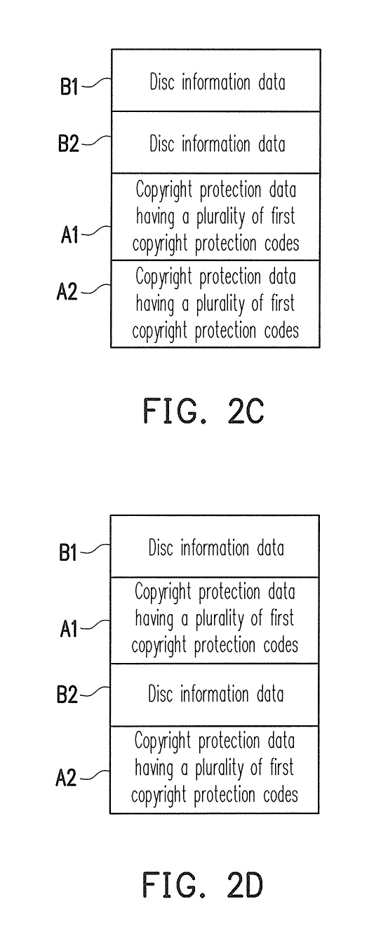

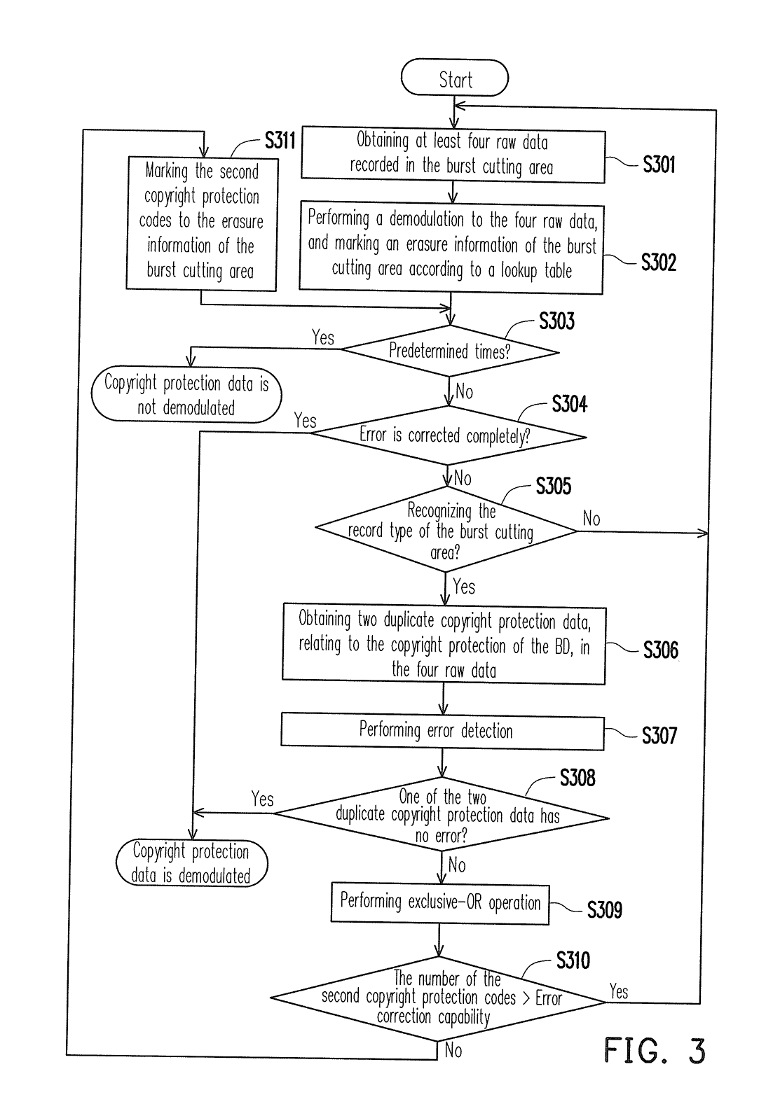

FIG. 1 is a diagram of a blu-ray disc (BD) 100 according to an embodiment of the present invention. FIGS. 2A to 2D are respectively a diagram of a record type for a burst cutting area BCA of the BD 100 according to an embodiment of the present invention. FIG. 3 is a flow chart of an erasure information marking method for the burst cutting area BCA of the BD 100 according to an embodiment of the present invention.

Referring to FIGS. 1 to 3, it can be clearly seen from FIG. 1 that the BD 100 has the burst cutting area BCA, a lead-in area LIA, and a data storage area DSA. The burst cutting area BCA at least records four raw data, wherein two of the four raw data are two duplicate copyright protection data A1 and A2; and the other two of the four raw data are two duplicate disc information data B1 and B2. The lead-in area LIA records at least one of the two duplicate disc information data B1 and B2. The data storage area DSA is used for recording user data.

The erasure information marking method for the burst cutting area BCA of the BD 100 according to the present embodiment includes the following Steps.

Firstly, obtaining at least four raw data A1, A2, B1 and B2 recorded in the burst cutting area BCA (in the Step S301). Next, performing a demodulation to the four raw data A1, A2, B1 and B2, and marking an erasure information of the burst cutting area BCA according to a lookup table (in the Step S302). In general, the lookup table mentioned in the Step 302 records four sets of burst cutting area data bits and channel bits.

In the present embodiment, by searching the channel bits in the lookup table can be obtained whether the data demodulated from the four raw data A1, A2, B1 and B2 have an error or not, so as to mark the erasure information of the burst cutting area BCA accordingly. However, such technology is a general knowledge/skill for one person having ordinary skilled in the art, so the detail description would be omitted herein.

Next, recording the number of accumulated times of performing the demodulation to the burst cutting area BCA, and determining whether the number of accumulated times of performing the demodulation to the burst cutting area BCA exceeds a predetermined times or not (in the Step S303). The predetermined times can be determined by the requirement of practice designing. In the present embodiment, when the number of accumulated times of performing the demodulation to the burst cutting area BCA exceeds the predetermined times (i.e. “Yes”), it represents that two duplicate copyright protection data A1 and A2, relating to the copyright protection of the BD 100, in the four raw data A1, A2, B1 and B2 are not demodulated. Accordingly, the BD 100 can not be accessed.

In the other hands, when the number of accumulated times of performing the demodulation to the burst cutting area BCA does not exceed the predetermined times (i.e. “No”), proceeding to the Step S304 for performing an error correction to the erasure information of the burst cutting area BCA. In the present embodiment, when the erasure information of the burst cutting area BCA is corrected completely (i.e. “Yes”), it represents that two duplicate copyright protection data A1 and A2, relating to the copyright protection of the BD 100, in the four raw data A1, A2, B1 and B2 are demodulated. Accordingly, the BD 100 can be accessed.

In the other hands, when the erasure information of the burst cutting area BCA is not corrected completely (i.e. “No”), proceeding to the Step S305 for recognizing the record type of the burst cutting area BCA according to the four raw data A1, A2, B1 and B2. Herein, please refer to FIGS. 2A to 2D, In the present embodiment, since the head of the two duplicate copyright protection data A1 and A2 is a specific value, and the head of the two duplicate disc information data B1 and B2 is an another specific value in the specification of BD 100. Accordingly, by two-two exclusive-matching for the four raw data A1, A2, B1 and B2 and using the characteristic with the smaller amount of the exclusive difference to classify, and thus confirming that the record type of the burst cutting area BCA belongs to the arrangement of A1A2B1B2, A1B1A2B2, B1B2A1A2, or B1A1B2A2.

In the other hands, if the record type of the burst cutting area BCA is not recognized according to the four raw data A1, A2, B1 and B2 (i.e. “No”), proceeding back and repeatedly performing to the Step 5301 to 5305 until the Step S303 determines that the number of accumulated times of performing the demodulation to the burst cutting area BCA exceeds the predetermined times. It means that two duplicate copyright protection data A1 and A2, relating to the copyright protection of the BD 100, in the four raw data A1, A2, B1 and B2 are not demodulated. Accordingly, the BD 100 can not be accessed.

After the record type of the burst cutting area BCA is recognized (i.e. “Yes”), proceeding to the Step 5306 for obtaining two duplicate copyright protection data A1 and A2, relating to the copyright protection of the BD 100, in the four raw data A1, A2, B1 and B2 according to the record type of the burst cutting area BCA. Next, performing an error detection to the two duplicate copyright protection data A1 and A2 (in the Step S307), and determining whether each of the two duplicate copyright protection data A1 and A2 has an error or not accordingly (in the Step S308). In the present embodiment, by performing an error correction code (ECC) decoding to the two duplicate copyright protection data A1 and A2 without marking the erasure information completely, and determining whether there is any error occurred to achieve the error detection. To be specific, the embodiment of determining whether each of the two duplicate copyright protection data A1 and A2 has the error or not can be adopted by checking whether a syndrome obtained by a result of performing the ECC decoding to the two duplicate copyright protection data A1 and A2 is zero or not, so as to obtain whether each of the two duplicate copyright protection data A1 and A2 has the error or not, but not limited thereto. For example, when the syndrome is zero, the two duplicate copyright protection data A1 and A2 both have no error; on the contrary, when the syndrome is not zero, the two duplicate copyright protection data A1 and A2 have errors.

In the present embodiment, when one of the two duplicate copyright protection data A1 and A2 has no error (i.e. “Yes”), it represents that two duplicate copyright protection data A1 and A2, relating to the copyright protection of the BD 100, in the four raw data A1, A2, B1 and B2 are demodulated. Accordingly, the BD 100 can be accessed. In the other hands, when the two duplicate copyright protection data A1 and A2 both have errors (i.e. “No”), the erasure information marking method for the burst cutting area BCA of the BD 100 according to the present embodiment would mark the erasure information of the burst cutting area BCA according to the difference between the two duplicate copyright protection data A1 and A2.

In the present embodiment, since each of the two duplicate copyright protection data A1 and A2 has a plurality of first copyright protection codes. Therefore, when the two duplicate copyright protection data A1 and A2 both have errors, proceeding to the Step S309 for performing an exclusive-OR operation to the two pluralities of first copyright protection codes respectively in the two duplicate copyright protection data A1 and A2, so as to obtain a plurality of second copyright protection codes from the different first copyright codes between the two pluralities of first copyright protection codes respectively in the two duplicate copyright protection data A1 and A2. And then, proceeding to the Step S310 for determining whether the number of the plurality of second copyright protection codes exceeds the system error correction capability or not.

When the number of the second copyright protection codes does not exceed the system error correction capability (i.e. “No”), proceeding to the Step S311 for marking the second copyright protection codes to the erasure infoimation of the burst cutting area BCA, and performing an error correction to the erasure information of the burst cutting area BCA so as to completely correct the erasure information of the burst cutting area BCA. Accordingly, it represents that two duplicate copyright protection data A1 and A2, relating to the copyright protection of the BD 100, in the four raw data A1, A2, B1 and B2 are demodulated, such that the BD 100 can be accessed. In the other hands, when the number of the second copyright protection codes exceeds the system error correction capability (i.e. “Yes”), proceeding back to the Steps S301 to S311.

From the above, it can be known that the erasure information marking method submitted by the present invention utilizes the special record format for the burst cutting area (BCA) of the BD to mark the erasure information by cross-matching corresponding positions between two duplicate copyright protection data. Therefore, the present invention can correctly mark the erasure information for the BCA of the BD so as to increase the ratio of the correct data and the burst error; promote the capability of processing the burst error; and promote the capability of positioning the error data position, such that the error correction capability for system can be used on the appropriate error data position.

Moreover, the present invention can limit the error correction capability to only the error detection capability without marking the erasure information, so as to achieve the error detection capability without defining as the original specification of the BD. Furthermore, since the lead-in area (LIA) of the BD has recorded the disc information data (i.e. the disc information data B1 and/or B2), so that the above embodiments just describe the example of marking the erasure information for the copyright protection data recorded in the burst cutting area, but in the other embodiment of the present embodiment, the erasure information for the disc information data recorded in burst cutting area also can be marked by similar manner, and such varied embodiments would fall in the scope of the present invention.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An erasure information marking method for a burst cutting area (BCA) of a blu-ray disc (BD), comprising:
obtaining at least four raw data recorded in the BCA;
recognizing a record type of the BCA according to the four raw data;
obtaining two duplicate copyright protection data in the four raw data according to the record type of the BCA; and
marking an erasure information of the BCA according to the difference between the two duplicate copyright protection data.

2. The erasure information marking method according to claim 1, wherein after the two duplicate copyright protection data are obtained, the erasure information marking method further comprising:
performing an error detection to the two duplicate copyright protection data, and determining whether each of the two duplicate copyright protection data has an error or not accordingly.

3. The erasure information marking method according to claim 2, wherein when one of the two duplicate copyright protection data has no error, the BD is accessed.

4. The erasure information marking method according to claim 2, wherein when the two duplicate copyright protection data both have errors, performing the step of marking the erasure information of the BCA according to the difference between the two duplicate copyright protection data.

5. The erasure information marking method according to claim 2, wherein the step of performing the error detection comprises performing an error correction code (ECC) decoding to the two duplicate copyright protection data without marking the erasure information completely, and determining whether there is any error occurred.

6. The erasure information marking method according to claim 5, wherein the step of determining whether each of the two duplicate copyright protection data has the error or not comprises:
checking whether a syndrome obtained by a result of performing the ECC decoding to the two duplicate copyright protection data is zero or not, so as to obtain whether each of the two duplicate copyright protection data has the error or not.

7. The erasure information marking method according to claim 6, wherein when the syndrome is zero, the two duplicate copyright protection data both have no error; and when the syndrome is not zero, the two duplicate copyright protection data have errors.

8. The erasure information marking method according to claim 4, wherein each of the two duplicate copyright protection data has a plurality of first copyright protection codes.

9. The erasure information marking method according to claim 8, wherein the step of marking the erasure information of the BCA according to the difference between the two duplicate copyright protection data comprises:
performing an exclusive-OR operation to the two pluralities of first copyright protection codes respectively in the two duplicate copyright protection data, so as to obtain a plurality of second copyright protection codes from the different first copyright codes between the two pluralities of first copyright protection codes respectively in the two duplicate copyright protection data; and
determining whether the number of the plurality of second copyright protection codes exceeds an error correction capability or not.

10. The erasure information marking method according to claim 9, wherein when the number of the second copyright protection codes exceeds the error correction capability, the erasure information marking method comprises:
re-obtaining the four raw data recorded in the BCA;
performing a demodulation to the four re-obtained raw data, and marking the erasure information of the BCA according to a lookup table;
recording the number of accumulated times of performing the demodulation to the BCA, and determining whether the number of accumulated times of performing the demodulation to the BCA exceeds a predetermined times or not; and
when the number of accumulated times of performing the demodulation to the BCA does not exceed the predetermined times, performing an error correction to the erasure information of the BCA and determining whether the erasure information of the BCA is corrected completely or not accordingly.

11. The erasure information marking method according to claim 10, wherein when the erasure information of the BCA is corrected completely, the BD is accessed.

12. The erasure information marking method according to claim 10, wherein when the erasure information of the BCA is not corrected completely, performing the step of recognizing the record type of the BCA according to the four raw data.

13. The erasure information marking method according to claim 10, wherein when the number of accumulated times of performing the demodulation to the BCA exceeds the predetermined times, the BD is not accessed.

14. The erasure information marking method according to claim 9, wherein when the number of the second copyright protection codes does not exceed the error correction capability, the erasure information marking method comprises:
marking the second copyright protection codes to the erasure information of the BCA; and
performing an error correction to the erasure information of the BCA so as to completely correct the erasure information of the BCA.

15. The erasure information marking method according to claim 14, wherein when the erasure information of the BCA is corrected completely, the BD is accessed.

16. The erasure information marking method according to claim 10, wherein when the record type of the BCA is not recognized according to the four raw data, performing the step of re-obtaining the four raw data recorded in the BCA.

17. The erasure information marking method according to claim 1, wherein the four raw data further comprises two duplicate disc information data.

18. The erasure information marking method according to claim 17, wherein a lead-in area of the BD records at least one of the two duplicate disc information data.
